(19) United States
(12) Patent Application Publication
(10) Pub. No.: US 2015/0046343 A1
(43) Pub. Date: Feb. 12, 2015

(54) USER DEVICE RECYCLING

(71) Applicant: Phantom Technologies, Inc., San Diego, CA (US)

(72) Inventor: Paul Michael Martini, San Diego, CA (US)

(73) Assignee: Phantom Technologies, Inc., San Diego, CA (US)

(21) Appl. No.: 13/962,785

(22) Filed: Aug. 8, 2013

(51) Int. Cl. G06Q 30/02

(52) U.S. Cl. CPC G06Q 30/0278
USPC 705/306

(57) ABSTRACT

Methods, systems, and apparatus, including computer programs encoded on computer storage media, for recycling a user device. One of the methods includes facilitating a device analysis application to be stored and installed on a user device, testing, by the device analysis application executing on the user device, one or more properties of the user device, determining an exchange value of the user device based at least in part on a result of testing the one or more properties of the user device, and presenting the determined exchange value to an operator of the user device.

### TECHNICAL FIELD

This specification relates to systems and techniques that facilitate the exchange of user devices, such as mobile telephones.

### BACKGROUND

Some companies receive used devices from consumers to refurbish and resell the used devices or for the materials utilized to build the used devices. Factors such as rapid technology change, low initial device cost, and planned, or inevitable, device obsolescence may contribute to a growing surplus of used computers, smart phones, tablets, and other electronic devices. Manufacturers sometimes offer replacement services where a consumer may send the manufacturer a used device and potentially receive a discount on goods purchased from the Manufacturer. This may allow the manufacturer to resell the used device, thereby reducing the quantity of electronic devices placed in landfills.

### SUMMARY

In general, one aspect of the subject matter described in this specification can be embodied in methods that include the actions of facilitating a device analysis application to be stored and installed on a user device, testing, by the device analysis application executing on the user device, one or more properties of the user device, determining an exchange value of the user device based at least in part on a result of testing the one or more properties of the user device, and presenting the determined exchange value to an operator of the user device. Other implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them, installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In particular, one implementation may include all the following features in combination. Testing the one or more properties may comprise requesting operator selection in an input interface to test the input interface, receiving selection of a portion of the input interface by an operator of the user device, and determining an input interface quality based on the received selection. The input interface may comprise a touch screen interface. The input interface may comprise one or more buttons. Testing the one or more properties may comprise testing a camera included in the user device.

In some implementations, testing the one or more properties comprises testing a display of the user device. Testing the display may comprise presenting a challenge-response test on the display, receiving input representing a response to the challenge-response test from an operator of the user device, and determining a display quality based on the received input. Testing the display may comprise presenting content on one or more portions of the display, receiving input in response to operator selection of an input interface based on presenting the content on one or more portions of the display, and determining a display quality based on receiving the input in response to operator selection.

In some implementations, testing the one or more properties comprises testing one or more components selected from the group consisting of a memory of the user device, a processor of the user device, a speaker of the user device, a microphone of the user device, one or more radio transmitters, and a battery of the user device. Testing the one or more properties may comprise determining whether a malicious software application is installed on the user device and/or determining whether an operating system of the user device has been modified.

In some implementations, testing the one or more properties comprises presenting a prompt, the prompt including a question regarding a component of the user device, receiving a response from an operator in reply to the prompt, the response specifying a condition of the component, and determining a quality of the component of the user device based on the response. The method may further comprise presenting, prior to presenting the prompt, an agreement that the determined exchange value is conditional upon the accuracy of the response, and receiving, based on presenting the agreement, input indicating whether the operator accepts the agreement or not, wherein the prompt is presented based on the input indicating that the operator accepts the agreement. The component may be selected from the group consisting of a display, a case, and an accessory.

In some implementations, the method further comprises receiving, by the user device, input indicating operator acceptance of the determined exchange value, and providing, based on receiving the input indicating operator acceptance, instructions for printing a shipping label, the shipping label for mailing the user device to receive at least a portion of the determined exchange value. The determined exchange value may be adjusted upon receipt of the user device by a third party. The determined exchange value may comprise an actual exchange value of the user device. The determined exchange value may comprise an estimated monetary exchange value of the user device.

In some implementations, the method further comprises receiving, by the user device, input indicating operator acceptance of the determined exchange value, and providing, based on receiving the input, data to an e-commerce exchange, wherein the data includes information about the user device and user device property data based on the tested properties of the user device. The method may further comprise determining a current resale value of the user device, wherein the determined exchange value is based on the current resale value. The user device may be a mobile telephone.

The subject matter described in this specification may be implemented in various implementations to realize one or more of the following potential advantages. In some implementations, a device analysis application reduces the need for expensive, specialized, or dedicated processes and/or equipment to test used devices. In some implementations, a device analysis application reduces overhead for a device trade-in company. In some implementations, a device analysis application provides an easier method for consumers to receive an estimated exchange value and/or for consumers to exchange used devices, e.g., the consumers do not need to go to a potentially inconvenient exchange location. In some implementations, a device analysis application provides a more accurate estimated exchange value. In some implementations, the use of a device analysis application provides an automated method for providing a buyer, e.g. a reseller, with information about a used device prior to sending the used device to the buyer.

Details of one or more implementations are set forth in the accompanying drawings and the description below. Other features, aspects, and potential advantages will become apparent from the description, the drawings, and the claims.

### BRIEF DESCRIPTION OF THE DRAWINGS

FIG. 1 is an example of a network system configured to FIG. 2 is a block diagram of a mobile device.

FIG. 3 is a flow diagram of a process for providing an estimated monetary exchange value for a user device.

FIG. 4 is a flow diagram of a process for testing a user device.

FIG. 5 is a block diagram of computing devices that may be used to implement the systems and methods described in this document.

Like reference numbers and designations in the various drawings indicate like elements.

### DETAILED DESCRIPTION

To provide consumers with a quicker, easier and more convenient exchange process, a trade-in service provides a device analysis application that may be downloaded to a user device. Once the device analysis application is installed on the user device, the device analysis applications tests one or more properties of the user device, such as the performance of the display, the keyboard, or the radio frequency transmitter, and presents a fixed or estimated monetary exchange value of the user device, where the monetary exchange value is based at least in part on the results of the tests.

When an operator of the user device accepts the monetary exchange value, the operator is provided with instructions for printing a shipping label and sending the user device to a third party. For example, the operator may send the user device to a trade-in center or a reseller.

After the user device is received by the third party, the third party may adjust the estimated monetary exchange value, for example based on the appearance of the user device or additional tests, and provide payment to the former owner of the user device. The third party may then sell the user device, e.g., to a consumer or a reseller.

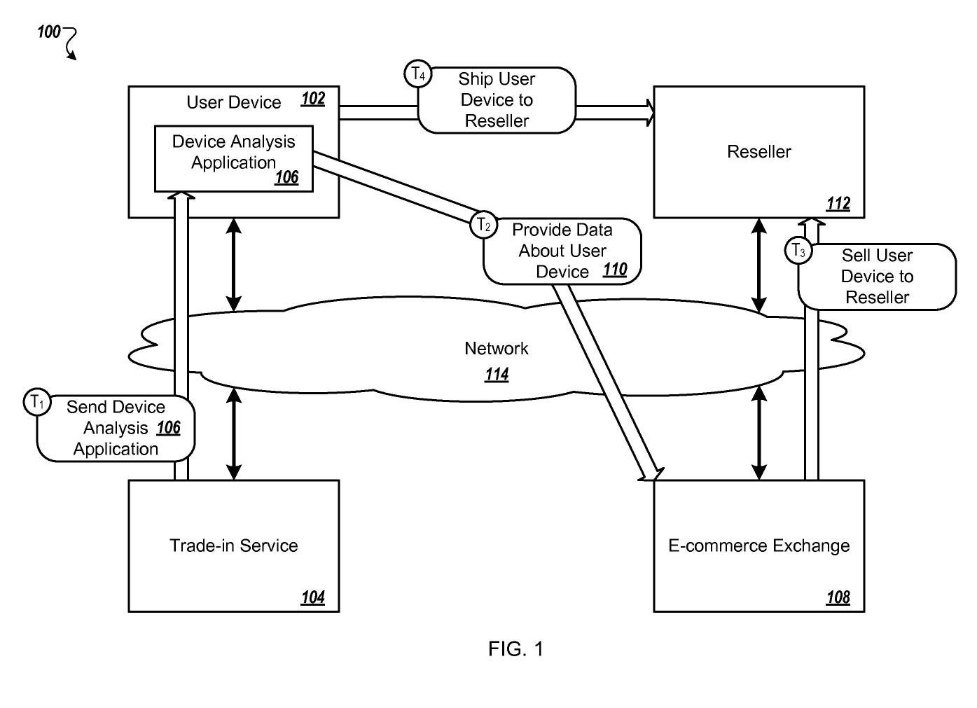

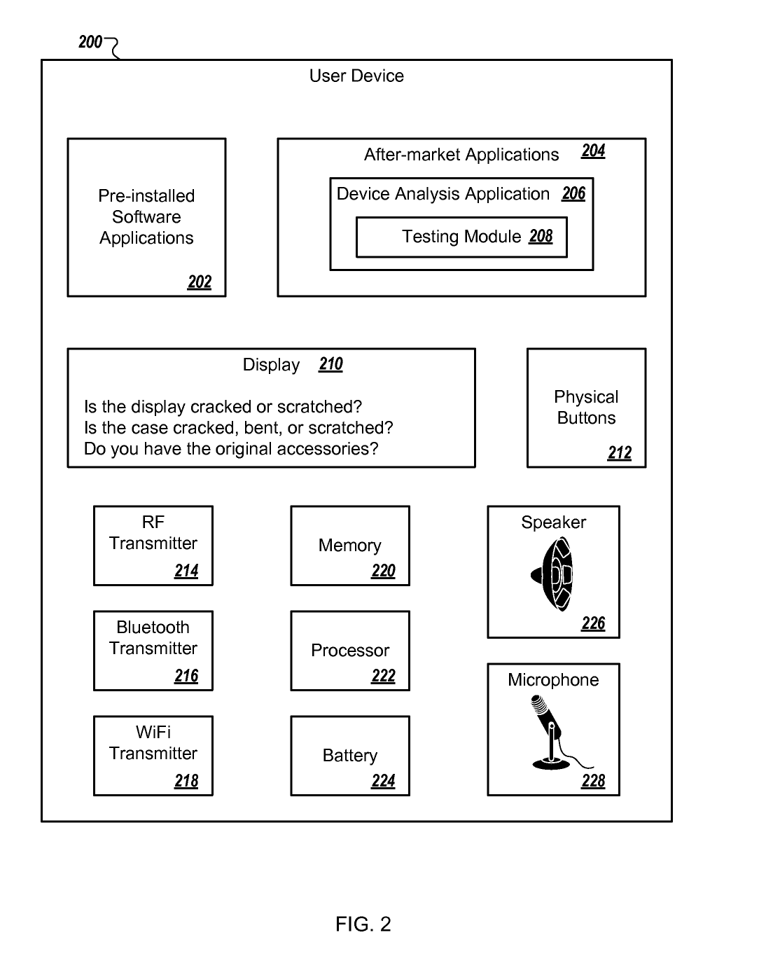

FIG. 1 is an example of a network system 100 configured to provide an exchange value for a user device 102. For example, a trade-in service 104 sends a device analysis application 106 to the user device 102 at time T₁, the user device 102 installs the device analysis application 106, and the device analysis application 106 analyzes one or more components and/or properties of the user device 102.

After the analysis, the device analysis application 106 presents an operator of the user device 102 with a fixed or estimated exchange value that is based on the results of the analysis. For example, the device analysis application 106 determines one or more properties associated with some of the components of the user device 102, such as the quality of components such as the display, touch screen keyboard, and/or camera, communicates with the trade-in service 104 to determine the exchange value based on the condition of those components, and presents the exchange value to the operator of the user device 102. The device analysis application 106 may present the exchange value on the display of the user device 102, or using a speaker of the user device 102, e.g., verbally, and/or may message the exchange value to the user, for example, using e-mail, voice-mail and/or text messaging.

When the operator of the user device 102 accepts the proposed exchange value, the operator may select an accept option presented with the proposed exchange value. For example, the device analysis application 106 may present the proposed exchange value with options to allow the operator to accept or decline the proposed exchange value. Similar options may be presented in other visual or verbal prompts.

Upon operator selection of the accept proposed exchange value option, the operator is presented with information regarding the exchange of the user device 102. For example, the operator receives an e-mail confirming the exchange of the user device 102 that includes shipping instructions for the operator to send the use device 102 to the trade-in service 104. The shipping instructions may include a pre-paid shipping label for the operator to use when sending the user device 102 to the trade-in service 104.

Upon receipt of the user device 102, the trade-in service 104 may conduct additional tests on the user device 102 and provide the former operator of the user device 102 with an adjusted exchange value or the proposed exchange value. For example, the proposed exchange value may be adjusted based on the additional tests performed by the trade-in service 104.

In some implementations, when the operator of the user device 102 accepts the proposed exchange value, the device analysis application 106 provides an e-commerce exchange 108 with data 110 about the user device 102 at time T₂. For example, the device analysis application 106 provides the make, the model, and component quality information for the user device 102 to the e-commerce exchange 108.

The e-commerce exchange 108 may be a hosting service that provides a web interface for consumers and/or resellers to purchase the user device 102 and other electronic devices. For example, the e-commerce exchange 108 may be an auction and/or buy-it-now service. In some examples, the e-commerce exchange 108 may be a wholesale service.

The e-commerce exchange 108 sells the user device 102 to a reseller 112 at time T₃. For example, the e-commerce exchange 108 lists the user device 102 on a web page and receives purchase information from the reseller 112 indicating that the reseller 112 would like to purchase the user device 102.

After the e-commerce exchange 108 sells the user device 102 to the reseller 112, the e-commerce exchange 108, or the trade-in service 104, provides the operator of the user device 102 with information about the sale. For example, the trade-in service 104 provides the device analysis application 106 with an updated exchange value and the device analysis application 106 presents the operator of the user device 102 with the updated exchange value and confirms that the operator will proceed with the exchange of the user device 102.

In some implementations, upon the sale of the user device 102, the operator receives shipping instructions for the user device 102 and is not presented with an updated exchange value. For example, when the updated exchange value is the same as the proposed exchange value, the device analysis application 106 does not present the operator of the user device 102 with the proposed exchange value a second time. The operator may then ship the user device 102, e.g., to the trade-in service 104, the e-commerce exchange 108, or the reseller 112, to confirm the exchange of the user device 102.

In some implementations, the updated exchange value is different than the exchange value. For example, the updated exchange value may be based on the value the reseller 112 paid the e-commerce exchange 108 for the user device 102.

When the operator of the user device 102 confirms that they will proceed with the exchange of the user device 102, the operator receives shipping instructions for the user device 102 and ships the user device 102 to the reseller 112 at time T₄. For example, the trade-in service 104 or the e-commerce exchange 108 emails or otherwise messages the shipping instructions to an email address associated with the operator of the user device 102.

In some implementations, the operator of the user device 102 ships the user device 102 to the trade-in service 104, the e-commerce exchange 108 or a physical location associated with the trade-in service 104 or the e-commerce exchange 108. For example, when the e-commerce exchange 108 sells multiple user devices to the reseller 112, the e-commerce exchange 108 may receive multiple user devices from operators of the user devices and send a single shipment of the multiple user devices to the reseller 112.

In some implementations, the exchange value of the user device 102 may be adjusted based on one or more properties associated with the user device 102 that are analyzed upon receipt of the user device 102. For example, when the operator of the user device 102 ships the user device 102 to the trade-in service 104, the trade-in service 104 may test the user device 102 and/or determine a physical quality of the user device 102, such as whether the display of the user device is cracked or scratched, and adjust the exchange value based on the tests or the physical quality. In some examples, the updated exchange value is based on the adjustment to the exchange value.

After the reseller 112 receives the user device 102, the trade-in service 104 provides the former operator of the user device 102 with payment. For example, the trade-in service 104 provides the former operator with the updated exchange value or the adjusted exchange value. In some implementations, the trade-in service 104 provides the updated exchange value to the former operator after the trade-in service 104 or the e-commerce exchange 108 receives the user device 102. In some implementations, the e-commerce exchange 108 provides the updated exchange value to the former operator of the user device 102.

In some implementations, the exchange value provided to the former operator of the user device 102 is a coupon or a discount. The coupon or discount may be associated with the purchase of a new user device, e.g., of a different make and/or model. In some implementations, the exchange value is a monetary exchange value, that is, cash that the former operator can spend as he or she pleases.

In some implementations, the exchange value is provided to another party. For example, the former operator of the user device 102 may indicate that the proceeds from the exchange should be donated to a specific charity, in which case the former operator may be provided with a receipt memorializing the charitable donation.

In some implementations, the trade-in service 104 provides different device analysis applications for different devices. For example, a first device analysis application may be associated with an audio video receiver and a second device analysis application may be associated with a mobile telephone. In some examples, a third device analysis application is associated with a particular make and/or model of mobile telephone and a fourth device analysis application is associated with a different model of mobile telephone.

In some implementations, the trade-in service 104 hosts a single device analysis application and the tests conducted by the device analysis application 106 on the user device 102 are selected by the device analysis application 106 based on the type of the user device 102. For example, the device analysis application 106 conducts a first set of tests on an audio video receiver and a second set of tests on a mobile telephone. In some examples, the tests conducted on the user devices may vary based on the make, model, and/or operating system or software of the corresponding user device.

In some implementations, the device analysis application 106 determines the proposed exchange value of the user device 102. In some implementations, the device analysis application 106 communicates with systems operated by the trade-in service 104 and/or the e-commerce exchange 108 to determine the proposed exchange value of the user device 102.

In some implementations, the proposed exchange value is associated with an expiration date. For example, the device analysis application 106 may present the exchange value to an operator of the user device 102 and indicate that the exchange value is valid for one week, after which the exchange value may change. The operator of the user device 102 may then accept the exchange value within the one week period, e.g., prior to the expiration date. If, however, the operator does not accept the estimate exchange value prior to the expiration date and later requests an exchange of the user device 102, e.g., after the one week period, the device analysis application 106 will present the operator with a new exchange value that may be the same as or different than the previous exchange value.

In some implementations, the e-commerce exchange 108 receives data about a plurality of user devices and sells the user devices in bulk to resellers. For example, the e-commerce exchange 108 may receive component quality information from multiple device analysis applications installed on the same brand and model of user device and sell the user devices in bulk to a single purchaser.

In some implementations, the e-commerce exchange 108 is a part of the trade-in service 104. For example, a server that provides the device analysis application 106 to the user device 102 also hosts the e-commerce exchange 108. In some implementations, the e-commerce exchange 108 is hosted by another service or company.

In some implementations, the device analysis application 106 provides the data 110 about the user device 102 to a third party that forwards the data to the e-commerce exchange 108. For example, the device analysis application 106 may provide the data 110 to the trade-in service 104 where the trade-in service 104 provides the data 110 to the e-commerce exchange 108.

In some implementations, upon receiving the user device 102 from the former operator, the trade-in service 104, the e-commerce exchange 108, or the reseller 112 restores the default settings of, or otherwise wipes clean, the user device 102. For example, when the reseller 112 receives the user device 102 the reseller 112 confirms that the user device 102 does not include any private information or aftermarket applications. If the reseller 112 determines that the user device 102 includes private information and/or an aftermarket application, the reseller 112 removes the private information and may remove the aftermarket application.

The user device 102 may include personal computers, set top boxes, televisions, mobile communication devices, and/or essentially any other appropriate device that can send and receive data over a network 114. The network 114, such as a local area network (LAN), wide area network (WAN), the Internet, or a combination thereof, connects the user device 102, the trade-in service 104, the e-commerce exchange 108, and the reseller 112.

FIG. 2 is a block diagram of a mobile device 200. The mobile device 200 is one example of the user device 102 shown in FIG. 1. For example, the mobile device 200 includes one or more pre-installed software applications 202. The pre-installed software applications 202 may include an operating system of the mobile device 200 in addition to other applications installed on the mobile device 200 prior to the receipt of the mobile device 200 by a consumer.

The mobile device 200 may include one or more after market applications 204. For example, the mobile device 200 may download and install a device analysis application 206 from an application server. The device analysis application 206 includes a testing module 208 that performs one or more tests of the mobile device 200.

For example, the testing module 208 may test the properties of a display 210. In some examples, the testing module 208 prompts an operator of the mobile device 200 with one or more questions regarding the quality of the display 210 to determine the properties of the display 210. Some examples of questions may include “Is the display cracked or scratched?” and “Are there any bad pixels on the display?”

In some implementations, when the operator of the mobile device 200 provides the testing module 208 with responses, the device analysis application 206 presents the operator with an agreement indicating that the estimated exchange value is conditional upon the accuracy of the responses.

In some implementations, when the display 210 is a touch screen display, the testing module 208 may request input from the operator using the display 210 to determine one or more properties of the display 210. For example, the testing module 208 may determine whether one or more touch screen keys, e.g., in a touch screen keyboard, operate correctly.

In some examples, the testing module 208 determines whether one or more portions of the display present content accurately and/or receive input. For example, the testing module 208 may prompt an operator regarding a portion of the display 210 such that the operator enters input into the mobile device 200 based on content presented in the portion of the display 210.

The mobile device 200 may include one or more physical buttons 212. The testing module 208 may determine the functions associated with the physical buttons 212 and determine whether the physical buttons 212 operate correctly based on operator interaction with the physical buttons 212. For example, the testing module 208 may prompt the operator to select one or more of the physical buttons 212 and determine whether input is received based on operator interaction with the physical buttons 212.

The mobile device 200 includes one or more radio transmitters. For example, the mobile device 200 includes a radio frequency transmitter 214, a Bluetooth transmitter 216, and a WiFi transmitter 218. The testing module 208 may examine the performance of the radio transmitters when testing the mobile device 200 and determining the quality of some of the components of the mobile device 200. For example, the testing module 208 may determine whether the radio frequency transmitter 214, the Bluetooth transmitter 216, and the WiFi transmitter 218 are functional.

The testing module 208 may analyze a memory 220, a processor 222, and a battery 224 of the mobile device 200. For example, the testing module 208 may determine whether the memory 220 includes a bad memory block, the speed of the processor 222, and/or the currently life of the battery 224.

The testing module 208 may test one or more properties of a speaker 226 and a microphone 228 included in the mobile device 200. For example, the testing module 208 may test both the speaker 226 and the microphone 228 to determine a loudness of the speaker 226 and/or a sensitivity of the microphone 228.

The mobile device 200 may include additional components. For example, the mobile device 200 may include a map application and a social network application as additional after-market applications 204.

In some implementations, the testing module 208 determines a speed of a browser installed on the mobile device 200. For example, the testing module 208 determines how long it takes to load a specific webpage based on a type of network used to access the Internet.

In some implementations, the testing module 208 prompts an operator regarding a quality of a case of the mobile device 200. For example, the testing module 208 may ask the operator whether the case is cracked, bent, or scratched.

In some implementations, the testing module 208 determines a quality of accessories associated with the mobile device 200. For example, the testing module 208 may prompt an operator of the mobile device 200 regarding whether the operator will exchange the accessories with the mobile device 200, e.g., whether the operator will send the accessories with the mobile device 200 to a reseller. In some examples, the testing module 208 determines whether the operator has the original accessories for the mobile device 200 and/or any after-market accessories. In some examples, in addition to determining whether the operator will include the accessories with the exchange of the user device, the testing module 208 prompts the operator regarding the quality of the accessories, such as whether the accessories are cracked, bent, non-functional, or otherwise damaged.

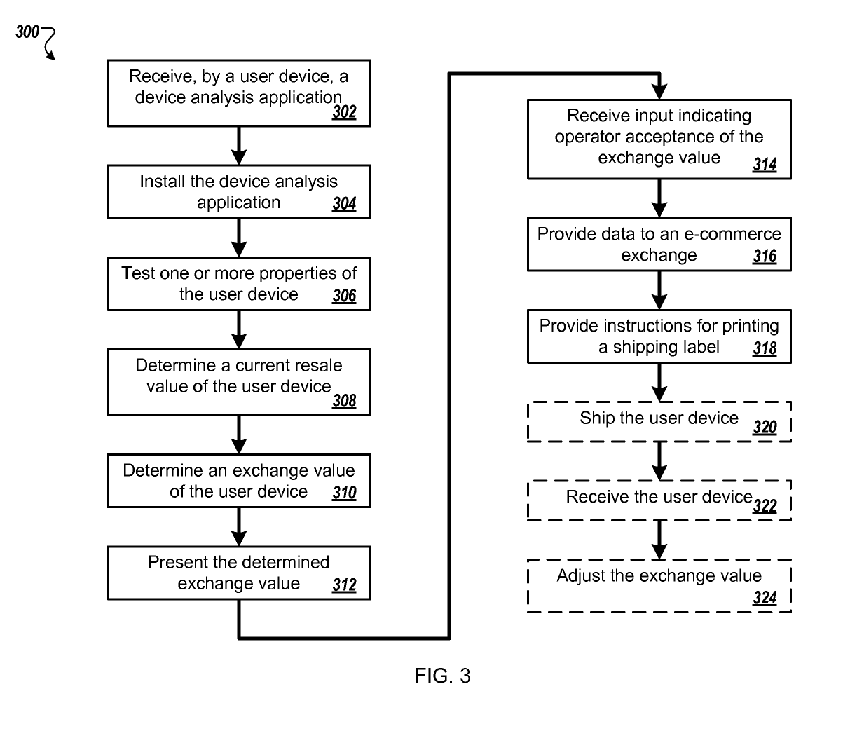

FIG. 3 is a flow diagram of a process 300 for providing an estimated monetary exchange value for a user device.

The process receives, by a user device, a device analysis application (302). For example, the device analysis application is stored on the user device. In some examples, the user device downloads the device analysis application using an application store or an application marketplace. In some examples, the user device receives the device analysis application from an application server.

In some implementations, the device analysis application is uploaded to the user device. For example, the user device may have network access, e.g., for accessing streaming content, but be unable to download applications from a network. In these examples, an operator of the user device may download the device analysis application to a memory, e.g., a removable memory, and use the memory to upload the device analysis application to the user device.

In some implementations, the user device is a mobile telephone.

The process installs the device analysis application (304). For example, an operating system of the user device installs the device analysis application on the user device.

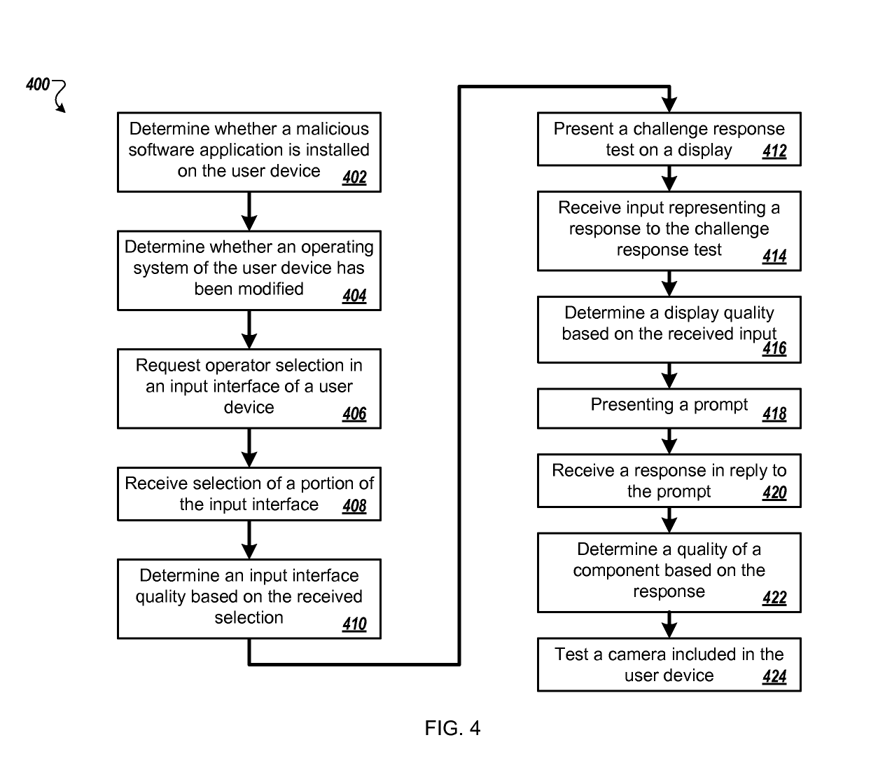

The process tests one or more properties of the user device (306). For example, the device analysis application tests the properties of the user device while executing on the user device. In some examples, the device analysis application performs one or more of the tests described below with reference to FIG. 4.

The process determines a current resale value of the user device (308). For example, the device analysis application determines the current resale value of the user device that a consumer or a reseller may pay for the user device.

The process determines an exchange value of the user device (310). For example, the device analysis application determines the exchange value based at least in part on a result of testing the one or more properties of the user device. In some implementations, the exchange value is based on the current resale value. For example, the exchange value is less than the current resale value. In some examples, the exchange value is an estimated and/or monetary exchange value.

In some examples, the exchange value is determined based on communication between the device analysis application and a server. For example, an e-commerce exchange provides the exchange value to the device analysis application based on the tested properties of the user device.

The process presents the determined exchange value (312). For example, the device analysis application presents the determined exchange value to the operator of the user device.

The process receives input indicating operator acceptance of the exchange value (314). For example, the device analysis application presents a prompt asking the operator whether they accept the exchange value as the value of the user device and receives input indicating operator acceptance of the exchange value. In some implementations, the prompt indicates that the exchange value may change upon receipt of the user device by a third party, e.g., after the third party analyzes the user device. In these implementations, the exchange value is an estimated exchange value.

The process provides data to an e-commerce exchange (316). For example, the device analysis application provides information about the tested properties of the user device and the make and model of the user device to the e-commerce exchange.

The process provides instructions for printing a shipping label (318). For example, the e-commerce exchange determines a reseller for the user device and provides human readable instructions for the operator of the user device to ship the user device to the reseller, e.g., where the instructions include a recommended shipping service for the user device. In some implementations, the instructions include computer instructions for printing the shipping label and after the shipping label is printed, the operator of the user device may apply the shipping label on a box containing the user device to ship the user device to the reseller.

In some implementations, the instructions are received from a trade-in service. In some implementations, the instructions are received from the reseller.

In some implementations, the instructions are for shipping the user device to the trade-in service. In some examples, the instructions are for shipping the user device to the e-commerce exchange.

The process ships the user device (320). For example, the former operator of the user device uses the instructions to physically ship the user device to the reseller.

The process receives the user device (322). For example, the reseller physically receives the user device.

The process adjusts the exchange value (324). For example, the trade-in service, or the e-commerce exchange, adjusts the exchange value of the user device. In some implementations, the trade-in service, or the e-commerce exchange, adjusts the exchange value only when either the trade-in service, or the e-commerce exchange, physically receives the user device.

In some implementations, the reseller provides the trade-in service and/or the e-commerce exchange with information about the user device upon receipt of the user device and the trade-in service, or the e-commerce exchange, adjusts the exchange value.

The order of steps in the process 300 described above is illustrative only, and the providing of the estimated monetary exchange value for the user device can be performed in different orders. For example, the process 300 may adjust the exchange value of the user device prior to providing the instructions for printing the shipping label.

In some implementations, the process 300 can include additional steps, fewer steps, or some of the steps can be divided into multiple steps. For example, the process 300 may provide the instruction for printing the shipping label, e.g., step 318, without shipping and receiving the user device or adjusting the estimated monetary exchange value, e.g., steps 320 through 324.

In some implementations, the process 300 provides the exchange value to the former operator of the user device. For example, the trade-in service physically mails a check to the former operator of the user device or wires money to an account associated with the former operator of the user device.

In some implementations, the process 300 presents an exchange value of the user device without determining a current resale value of the user device. For example, the exchange value may be based on the tested properties of the user device. In some examples, the exchange value may be based on an average resale value of the user device or similar devices to resellers over a predetermined period of time.

In some implementations, the estimated monetary exchange value is an actual exchange value of the user device. For example, after the reseller receives the user device, the reseller determines that the condition of the user device determined by the device analysis application is accurate and the trade-in service provides the former operator of the user device with the estimated monetary exchange value.

FIG. 4 is a flow diagram of a process 400 for testing a user device. For example, the process 400 can be used by the device analysis application 106 from the network system 100.

The process determines whether a malicious software application is installed on the user device (402). For example, the device analysis application compares a list of applications installed on the user device with blacklist of malicious software applications to determine if one of the applications installed on the user device is on the blacklist.

In some implementations, when the device analysis application identifies a blacklisted application, the exchange value is less than if no blacklisted applications were identified on the user device. For example, it may require more time to remove a blacklisted application from a user device than a non-blacklisted application, reducing the exchange value of a user device with one or more blacklisted applications compared to a user device that does not have any blacklisted applications installed.

The process determines whether an operating system of the user device has been modified (404). For example, the device analysis application determines whether an operator of the user device has gained unauthorized root access to the operating system of the user device.

In some implementations, when the device analysis application identifies a modified operating system, the exchange value is less than if the operating system were unmodified. For example, a user device with a modified operating system may require a reseller, or a trade-in service, to restore the operating system to an unmodified version, reducing the exchange value of a user device with a modified operating system compared to a user device with an unmodified operating system.

The process requests operator selection in an input interface of a user device (406). For example, the device analysis application prompts the operator with a verbal or a visual prompt requesting operator selection of a portion of the input interface. For example, the input interface may be a touch screen display, a physical keyboard or keypad, or one or more other keys or buttons.

The process receives selection of a portion of the input interface (408). For example, the device analysis application receives input indicating that the operator has selected the portion of the input interface. In some implementations, the input interface is a touch screen display. In some implementations, the input interface includes one or more keys on the user device. For example, the input interface may include a keypad. In some examples, the input interface includes a keyboard, e.g., a physical keyboard or a touch screen keyboard. In some examples, the input interface includes one or more buttons on the user device, e.g., physical buttons or software generated buttons.

The process determines an input interface quality based on the received selection (410). For example, the device analysis application determines whether a touch screen display and a physical button function properly based on multiple selections associated with the touch screen display and a selection associated with the physical button.

The process presents a challenge response test on a display (412). For example, the device analysis application presents a CAPTCHA on the display of the user device. In some implementations, the device analysis application presents content on one or more portions of the display to test the respective portions of the display.

The process receives input representing a response to the challenge response test (414). For example, the user device receives a selection by an operator of the user device and provides input indicating the selection to the device analysis application. In some implementations, the device analysis application receives input in response to operator selection of an input interface based on presenting the content on one or more portions of the display.

The process determines a display quality based on the received input (416). For example, when the device analysis application prompts a user asking what color is presented on a portion of the display as the challenge response test, the device analysis application determines the display quality based on the accuracy of the received input. In some implementations, the device analysis application determines a display quality based on receiving the input in response to operator selection.

The process presents a prompt (418). For example, the device analysis application prompts the operator of the user device regarding a property of the user device or an accessory associated with the user device. Some examples of prompts may include “Do you have the original accessories?”, “Are the accessories in good condition?”, “Is the case cracked, bent, or scratched?”, and “Is the display cracked or scratched?”

The process receives a response in reply to the prompt (420). For example, the user device receives selection of a portion of an input interface, e.g., a key, and provides the input indicated by the selection to the device analysis application.

The process determines a quality of a component based on the response (422). For example, the device analysis application determines that the case of the user device is in good condition based on the response “no” to the prompt “Is the case cracked, bent, or scratched?”

The process tests a camera included in the user device (424). For example, the device analysis application prompts an operator of the user device to take a picture and the device analysis application analyzes the picture to determine a camera picture quality. In some implementations, the device analysis application tests the blur of the picture. In some implementations, the device analysis application tests the focus of the camera. The device analysis application may perform any appropriate algorithm to test the camera picture quality.

The order of steps in the process 400 described above is illustrative only, and the testing of the user device can be performed in different orders. For example, the device analysis application may test the camera prior to determining the display quality.

In some implementations, the process 400 can include additional steps, fewer steps, or some of the steps can be divided into multiple steps. For example, the device analysis application may perform steps 406 through 410 without performing the other steps of the process 400. In some implementations, the device analysis application performs steps 412 through 416 without performing the other steps in the process 400. In some examples, the device analysis application performs steps 418 through 422 without performing the other steps in the process 400.

In some implementations, the device analysis application presents an agreement that an exchange value is conditional upon the accuracy of an operator response prior to presenting a prompt, e.g., performing step 418. The device analysis application may then receive, based on presenting the agreement, input indicating whether the operator accepts the agreement or not, and present the prompt based on the input indicating that the operator accepts the agreement.

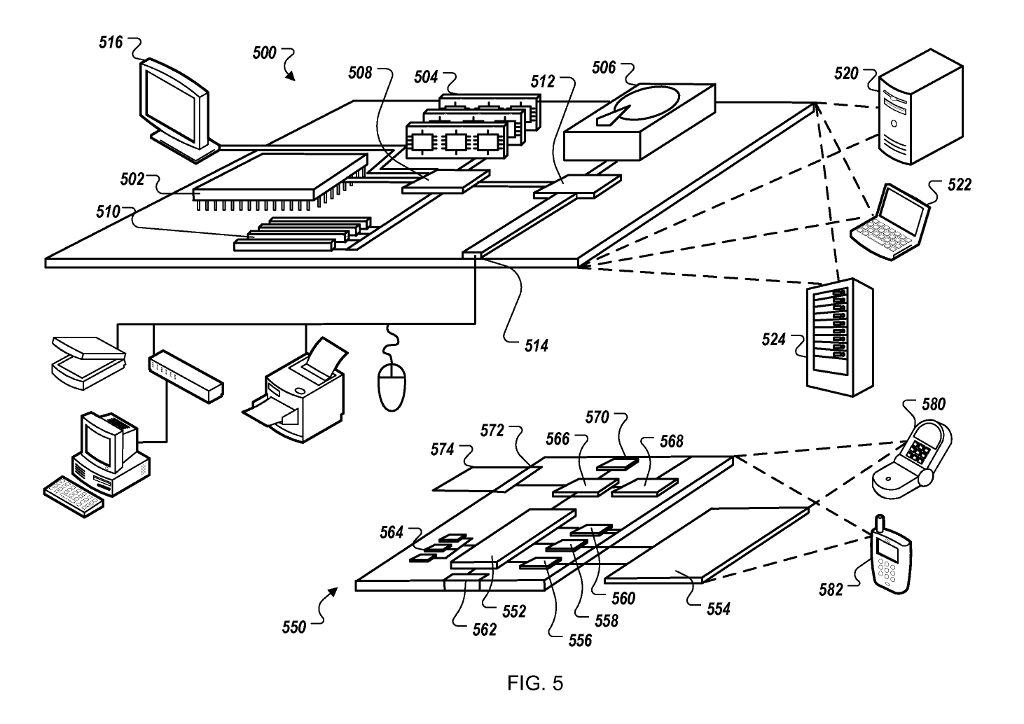

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. Additionally computing device 500 or 550 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations of the inventions described and/or claimed in this document.

Computing device 500 includes a processor 502, memory 504, a storage device 506, a high speed interface 508 connecting to memory 504 and high speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high speed controller 508 is coupled to memory 504, display 516 (e.g., through a graphics processor or accelerator), and to high speed expansion ports 510, which may accept various expansion cards (not shown). In the implementation, low speed controller 512 is coupled to storage device 506 and low speed expansion port 514. The low speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. Additionally, the processor may be implemented using any of a number of architectures. For example, the processor 502 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552 that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

This document describes technologies that can be applied to a wide range of uses, which are designed and intended to be beneficial for all users involved. However, some of the technologies described may be put to illegitimate, malicious, and even illegal ends by bad actors. This is true with almost any technology, but there is often a greater sensitivity when a technology interacts with a user's security and private information. The described technologies all are designed to operate in an environment and in a manner that respects the rights of all users. As such, features such as user notification, opt-in and opt-out procedures, and privacy settings are available options to be used to ensure user security and privacy are respected.

Although a few implementations have been described in detail above, other modifications are possible. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A method performed by a data processing apparatus, the method comprising:
facilitating a device analysis application to be stored and installed on a user device;
testing, by the device analysis application executing on the user device, properties of the user device, the testing comprising:
determining whether a malicious software application is installed on the user device or an operating system of the user device has been modified;
determining whether one or more transmitters included in the user device are functional;
requesting an operator of the user device to identify what color is presented on a portion of a display of the user device;
receiving input representing a response to the request from the operator of the user device indicating the color presented on the portion of the display;
presenting content on one or more portions of the display;
receiving, in response to the presentation of the content on one or more portions of the display, input in response to operator selection of the one or more portions of the display; and
determining a display quality based on the received input representing a response to the request from the operator of the user device indicating the color presented on the portion of the display and the received input in response to operator selection of the one or more portions of the display;
determining, by the device analysis application executing on the user device, an exchange value of the user device based at least in part on a result of testing the properties of the user device including the display quality, the determination whether a malicious software application is installed on the user device or the operating system of the user device has been modified, and the determination whether the transmitters included in the user device are functional; and
presenting the determined exchange value to an operator of the user device.

2. The method of claim 1, wherein testing the properties comprises:
requesting operator selection in an input interface to test the input interface;
receiving selection of a portion of the input interface by the operator of the user device; and
determining an input interface quality based on the received selection.

3. (canceled)

4. The method of claim 1, wherein testing the properties comprises:
presenting a challenge-response test on the display;
receiving input representing a response to the challenge-response test from an operator of the user device; and
determining a display quality using an accuracy of the received input.

5-6. (canceled)

7. The method of claim 1, wherein testing the properties comprises:
presenting a prompt, the prompt including a question regarding a component of the user device;
receiving a response from the operator in reply to the prompt, the response specifying a condition of the component; and
determining a quality of the component of the user device based on the response.

8. The method of claim 7, further comprising:
presenting, prior to presenting the prompt, an agreement that the determined exchange value is conditional upon the accuracy of the response when the response is verified by a third party; and
receiving, based on presenting the agreement, input indicating whether the operator accepts the agreement or not, wherein the prompt is presented in response to the input indicating that the operator accepts the agreement.

9. The method of claim 1, further comprising:
receiving, by the user device, input indicating operator acceptance of the determined exchange value; and
providing, based on receiving the input indicating operator acceptance, instructions for printing a shipping label, the shipping label for mailing the user device to receive at least a portion of the determined exchange value.

10. The method of claim 1, further comprising:
receiving, by the user device, input indicating operator acceptance of the determined exchange value; and
providing, based on receiving the input, data to an e-commerce exchange, wherein the data includes information about the user device and the tested properties of the user device including the display quality.

11. A non-transitory computer storage medium encoded with instructions that, when executed by one or more computers, cause the one or more computers to perform operations comprising:
facilitating a device analysis application to be stored and installed on a user device;
testing, by the device analysis application executing on the user device, properties of the user device, the testing comprising:
determining whether a malicious software application is installed on the user device or an operating system of the user device has been modified;
determining whether one or more transmitters included in the user device are functional;
requesting an operator of the user device to identify what color is presented on a portion of a display of the user device;
receiving input representing a response to the request from the operator of the user device indicating the color presented on the portion of the display;
presenting content on one or more portions of the display;
receiving, in response to the presentation of the content on one or more portions of the display, input in response to operator selection of the one or more portions of the display; and
determining a display quality based on the received input representing a response to the request from the operator of the user device indicating the color presented on the portion of the display and the received input in response to operator selection of the one or more portions of the display;
determining, by the device analysis application executing on the user device, an exchange value of the user device based at least in part on a result of testing the properties of the user device including the display quality, the determination whether a malicious software application is installed on the user device or the operating system of the user device has been modified, and the determination whether the transmitters included in the user device are functional; and
presenting the determined exchange value to an operator of the user device.

12. The computer storage medium of claim 11, wherein testing the properties comprises:
requesting operator selection in an input interface to test the input interface;
receiving selection of a portion of the input interface by the operator of the user device; and
determining an input interface quality based on the received selection.

13. (canceled)

14. The computer storage medium of claim 11, wherein testing the properties comprises:
presenting a challenge-response test on the display;
receiving input representing a response to the challenge-response test from an operator of the user device; and
determining a display quality using an accuracy of the received input.

15-16. (canceled)

17. The computer storage medium of claim 11, wherein testing the properties comprises:
presenting a prompt, the prompt including a question regarding a component of the user device;
receiving a response from the operator in reply to the prompt, the response specifying a condition of the component; and
determining a quality of the component of the user device based on the response.

18. The computer storage medium of claim 17, the operations further comprising:
presenting, prior to presenting the prompt, an agreement that the determined exchange value is conditional upon the accuracy of the response when the response is verified by a third party; and
receiving, based on presenting the agreement, input indicating whether the operator accepts the agreement or not, wherein the prompt is presented in response to the input indicating that the operator accepts the agreement.

19. The computer storage medium of claim 11, the operations further comprising:
receiving, by the user device, input indicating operator acceptance of the determined exchange value; and
providing, based on receiving the input indicating operator acceptance, instructions for printing a shipping label, the shipping label for mailing the user device to receive at least a portion of the determined exchange value.

20. The computer storage medium of claim 11, the operations further comprising:
receiving, by the user device, input indicating operator acceptance of the determined exchange value; and
providing, based on receiving the input, data to an e-commerce exchange, wherein the data includes information about the user device and information about the tested properties of the user device including the display quality.

21. A system comprising:
one or more computers and one or more storage devices storing instructions that are operable, when executed by the one or more computers, to cause the one or more computers to perform operations comprising:
facilitating a device analysis application to be stored and installed on a user device;
testing, by the device analysis application executing on the user device, properties of the user device, the testing comprising:
determining whether a malicious software application is installed on the user device or an operating system of the user device has been modified;
determining whether one or more transmitters included in the user device are functional;
requesting an operator of the user device to identify what color is presented on a portion of a display of the user device;
receiving input representing a response to the request from the operator of the user device indicating the color presented on the portion of the display;
presenting content on one or more portions of the display;
receiving, in response to the presentation of the content on one or more portions of the display, input in response to operator selection of the one or more portions of the display; and
determining a display quality based on the received input representing a response to the request from the operator of the user device indicating the color presented on the portion of the display and the received input in response to operator selection of the one or more portions of the display;
determining, by the device analysis application executing on the user device, an exchange value of the user device based at least in part on a result of testing the properties of the user device including the display quality, the determination whether a malicious software application is installed on the user device or the operating system of the user device has been modified, and the determination whether the transmitters included in the user device are functional; and
presenting the determined exchange value to an operator of the user device.

22. The system of claim 21, wherein testing the properties comprises:
requesting operator selection in an input interface to test the input interface;
receiving selection of a portion of the input interface by the operator of the user device; and
determining an input interface quality based on the received selection.

23. (canceled)

24. The system of claim 21, wherein testing the properties comprises:
presenting a challenge-response test on the display;
receiving input representing a response to the challenge-response test from an operator of the user device; and
determining a display quality using an accuracy of the received input.

25-26. (canceled)

27. The system of claim 21, wherein testing the properties comprises:
presenting a prompt, the prompt including a question regarding a component of the user device;
receiving a response from the operator in reply to the prompt, the response specifying a condition of the component; and
determining a quality of the component of the user device based on the response.

28. The system of claim 27, the operations further comprising:
presenting, prior to presenting the prompt, an agreement that the determined exchange value is conditional upon the accuracy of the response when the response is verified by a third party; and
receiving, based on presenting the agreement, input indicating whether the operator accepts the agreement or not, wherein the prompt is presented in response to the input indicating that the operator accepts the agreement.

29. The system of claim 21, the operations further comprising:
receiving, by the user device, input indicating operator acceptance of the determined exchange value; and
providing, based on receiving the input indicating operator acceptance, instructions for printing a shipping label, the shipping label for mailing the user device to receive at least a portion of the determined exchange value.

30. The system of claim 21, the operations further comprising:
receiving, by the user device, input indicating operator acceptance of the determined exchange value; and
providing, based on receiving the input, data to an e-commerce exchange, wherein the data includes information about the user device and information about the tested properties of the user device including the display quality.

31. The method of claim 1, wherein testing the properties of the user device comprises:
determining a battery life of the user device;
determining a loudness of a speaker included in the user device; and
determining a sensitivity of a microphone included in the user device, wherein determining, by the device analysis application executing on the user device, the exchange value of the user device comprises determining, by the device analysis application executing on the user device, the exchange value of the user device using the determination of the battery life of the user device, the determination of the loudness of the speaker included in the user device and the determination of the sensitivity of the microphone included in the user device.

32. The method of claim 1, wherein testing the properties of the user device comprises determining whether a memory in the user device includes a bad memory block, wherein determining, by the device analysis application executing on the user device, the exchange value of the user device comprises determining, by the device analysis application executing on the user device, the exchange value of the user device using the determination whether the memory in the user device includes a bad memory block.

33. The method of claim 1, wherein:
the display comprises a touch screen display; and
receiving input in response to operator selection of the one or more portions of the display in response to the presentation of the content on one or more portions of the display comprises receiving input from the touch screen display.

34. The method of claim 1, wherein testing the properties comprises determining how long it takes to load a specific webpage, wherein determining, by the device analysis application executing on the user device, the exchange value of the user device comprises determining, by the device analysis application executing on the user device, the exchange value of the user device using the determination of how long it takes to load the specific webpage.

35. The method of claim 34, wherein determining how long it takes to load the specific webpage comprises determining how long it takes to load the specific webpage given a type of network used by the user device to access the Internet.
